(19) United States
(12) Patent Application Publication
(10) Pub. No.: US 2025/0095443 A1
(43) Pub. Date: Mar. 20, 2025

(54) OUTPUT ACCUMULATION SYSTEMS AND METHODS IN ELECTRONIC GAMING

(71) Applicant: Aristocrat Technologies, Inc., Las Vegas, NV (US)

(72) Inventors: Deanna Hickox, Georgetown, TX (US); Hanna Sanborn, Georgetown, TX (US); Scott Hopkins, Austin, TX (US); Erick Ching, Cedar Park, TX (US); Jennifer Mizzi, Ewa Beach, HI (US); Rogelio Decasa, Jr., Renton, WA (US); Nathan Warms, Austin, TX (US); Zachary Smith, Austin, TX (US); Steven Richardson, Round Rock, TX (US); Kelly Lockheed, Elkridge, MD (US); Carlyn Albright, Reno, NV (US); Ginette McKay, Austin, TX (US); Nicholas Farina, Granger, IN (US)

(21) Appl. No.: 18/467,529

(22) Filed: Sep. 14, 2023

(51) Int. Cl. G07F 17/32

(52) U.S. Cl. CPC G07F 17/3267; G07F 17/3213; G07F 17/3244

(57) ABSTRACT

An electronic gaming system including a memory and a processor is described. The processor is configured to cause display of a first display area including a plurality of symbol positions for an electronic game, determine a respective symbol for each symbol position of the plurality of symbol positions, and cause at least one bonus symbol to advance at least one symbol position of the plurality of symbol positions toward an edge of the plurality of symbol positions. The processor is also configured to cause display of at least a portion of the at least one bonus symbol in a second display area wherein display of at least the portion of the at least one bonus symbol indicates that an output amount will be provided and cause the output amount associated with the at least one bonus symbol to be provided.

### TECHNICAL FIELD

The field of disclosure relates generally to electronic gaming, and more specifically, to output accumulation systems and methods in electronic gaming.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming device including at least one memory with instructions stored thereon and at least one processor in communication with the at least one memory is described. The instructions, when executed by the at least one processor, cause the at least one processor to cause display of a first display area including a plurality of symbol positions for an electronic game, determine a respective symbol for each symbol position of the plurality of symbol positions for a play of the electronic game wherein the respective symbols include at least one bonus symbol and wherein the at least one bonus symbol is associated with an output amount, and cause the at least one bonus symbol to advance at least one symbol position of the plurality of symbol positions toward an edge of the plurality of symbol positions for a next play of the electronic game. The instructions also cause the at least one processor to, after a play of the electronic game where the at least one bonus symbol is displayed at a symbol position of the plurality of symbol positions adjacent to the edge of the plurality of symbol positions, cause display of at least a portion of the at least one bonus symbol in a second display area wherein display of at least the portion of the at least one bonus symbol indicates that the output amount will be provided for the electronic game and cause the output amount associated with the at least one bonus symbol to be provided.

In another aspect, at least one non-transitory computer-readable storage medium with instructions stored thereon is described. The instructions, in response to execution by at least one processor, cause the at least one processor to cause display of a first display area including a plurality of symbol positions for an electronic game, determine a respective symbol for each symbol position of the plurality of symbol positions for a play of the electronic game wherein the respective symbols include at least one bonus symbol and wherein the at least one bonus symbol is associated with an output amount, and cause the at least one bonus symbol to advance at least one symbol position of the plurality of symbol positions toward an edge of the plurality of symbol positions for a next play of the electronic game. The instructions also cause the at least one processor to, after a play of the electronic game where the at least one bonus symbol is displayed at a symbol position of the plurality of symbol positions adjacent to the edge of the plurality of symbol positions, cause display of at least a portion of the at least one bonus symbol in a second display area wherein display of at least the portion of the at least one bonus symbol indicates that the output amount will be provided for the electronic game and cause the output amount associated with the at least one bonus symbol to be provided.

In yet another aspect, a method of electronic gaming implemented by at least one processor in communication with at least one memory is described. The method includes causing display of a first display area including a plurality of symbol positions for an electronic game, determining a respective symbol for each symbol position of the plurality of symbol positions for a play of the electronic game wherein the respective symbols include at least one bonus symbol, and wherein the at least one bonus symbol is associated with an output amount, and causing the at least one bonus symbol to advance at least one symbol position of the plurality of symbol positions toward an edge of the plurality of symbol positions for a next play of the electronic game. The method also includes, after a play of the electronic game where the at least one bonus symbol is displayed at a symbol position of the plurality of symbol positions adjacent to the edge of the plurality of symbol positions, causing display of at least a portion of the at least one bonus symbol in a second display area wherein display of at least the portion of the at least one bonus symbol indicates that the output amount will be provided for the electronic game and causing the output amount associated with the at least one bonus symbol to be provided.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates an example screenshot and/or interface of an electronic game, as described herein.

FIG. 5 illustrates another example screenshot and/or interface of the electronic game shown in FIG. 4.

FIG. 6 illustrates another example screenshot and/or interface of the electronic game shown in FIG. 4.

FIG. 7 illustrates another example screenshot and/or interface of the electronic game shown in FIG. 4.

FIG. 8 illustrates another example screenshot and/or interface of the electronic game shown in FIG. 4.

FIG. 9 illustrates another example screenshot and/or interface of the electronic game shown in FIG. 4.

FIG. 10 illustrates an example screenshot and/or interface of an electronic game including output accumulation, as described herein.

FIG. 11 illustrates another example screenshot and/or interface of the electronic game shown in FIG. 10.

FIG. 12 illustrates another example screenshot and/or interface of the electronic game shown in FIG. 10.

FIG. 13 illustrates another example screenshot and/or interface of the electronic game shown in FIG. 10.

FIG. 14 illustrates another example screenshot and/or interface of the electronic game shown in FIG. 10.

FIG. 15 illustrates another example screenshot and/or interface of the electronic game shown in FIG. 10.

FIG. 16 illustrates an example screenshot and/or interface of the electronic game shown in FIG. 18 being triggered.

FIG. 17 illustrates another example screenshot and/or interface of the electronic game shown in FIG. 18 being triggered.

FIG. 18 illustrates an example screenshot and/or interface of an electronic game.

FIG. 19 illustrates another example screenshot and/or interface of the electronic game shown in FIG. 18.

FIG. 20 illustrates another example screenshot and/or interface of the electronic game shown in FIG. 18.

FIG. 21 illustrates another example screenshot and/or interface of the electronic game shown in FIG. 18.

FIG. 22 illustrates an example screenshot and/or interface of an electronic game, as described herein.

FIG. 23 illustrates another example screenshot and/or interface of the electronic game shown in FIG. 22.

FIG. 24 illustrates another example screenshot and/or interface of the electronic game shown in FIG. 22.

FIG. 25 illustrates another example screenshot and/or interface of the electronic game shown in FIG. 22.

FIG. 26 illustrates another example screenshot and/or interface of the electronic game shown in FIG. 22.

FIG. 27 illustrates another example screenshot and/or interface of the electronic game shown in FIG. 22.

FIG. 28 illustrates an example method for output accumulation in electronic gaming, as described herein.

### DETAILED DESCRIPTION

Described herein are output accumulation systems and methods in electronic gaming. In the example embodiment, “walking” symbols move across reels in an electronic game (e.g., left to right, one reel per spin). Once the walking symbols reach an edge of an outermost reel, they “fall off” the reels and are accumulated in a prize bank. At the end of the electronic game, the award accumulated in the prize bank is presented (e.g., to a player account). Accordingly, output amounts associated with the walking symbols that fall off the reels are still presented at the conclusion of the electronic game rather than simply disappearing. For instance, in the example embodiment the walking symbols are cash-on-reel (COR) symbols (e.g., symbols with values displayed thereon and associated therewith) and values associated with the COR symbols accumulated in the prize bank are presented at the end of the electronic game.

The technical problems addressed herein include at least one of: (i) inability of known systems to collect walking symbols that leave reels and provide an award associated therewith while controlling RTP; (ii) inability of known systems to efficiently communicate that collected walking symbols that leave reels will be provided as an award at, for example, display screens of limited size (e.g., smart phone screens); and (iii) inability of known systems to provide additional bonuses, along with collected walking symbols that leave reels, while controlling RTP.

The resulting technical effect and/or technical benefits achieved by this disclosure include at least one of: (i) collecting walking symbols that leave reels and providing an award associated therewith while controlling RTP; (ii) efficiently communicating that collected walking symbols that leave reels will be provided as an award at, for example, display screens of limited size (e.g., smart phone screens); and (iii) providing additional bonuses, along with collected walking symbols that leave reels, while controlling RTP.

As one example, certain technical improvements are provided by controlling walking symbols that are controlled to move across reels each spin. Computer resources are saved by the predetermination of where certain symbols will be displayed (e.g., walking symbols will appear one symbol position to the right) and thus less determinations need to be made as to which new symbols to provide. Determining which new symbols to provide on reels can be a computationally-heavy process that may require the use of one or more random number generator (RNG) calls and one or more lookup tables (e.g., or in some other examples, such as Class 2, different bingo pattern awards, bingo calls, and bingo card daubs). Accordingly, by using walking symbols instead of entirely new sets of symbols with each reel spin, computer resources are saved and computer components operate more efficiently.

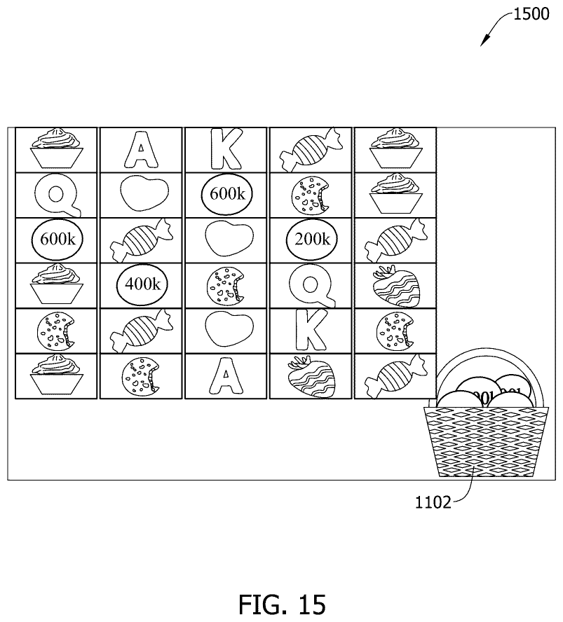

As another example, technical improvements in controlling RTP are provided. By implementing walking symbols associated with specific outcome amounts (e.g., COR symbols each associated with a respective amount of credits), RTP can be controlled while saving computer resources and improving computer efficiency. For instance, COR symbols collected (e.g., see FIG. 15) are indicative of an output amount for an electronic game. To manage RTP, more and/or less COR symbols can be added to the reels and controlled to either “fall” off (e.g., and the value associated therewith be provided) or remain on the reels at the end of gameplay (e.g., by controlling the COR symbols and a number of spins remaining in the electronic game) in order to achieve a target RTP.

As a further example, if there are two spins remaining in play of an electronic game including a 5×5 matrix where walking symbols falling off the reels are associated with output amounts that will be provided, new walking symbols that are provided on the three leftmost reels will not be provided in the game outcome (e.g., because walking symbols placed thereon for either of the two remaining spins will not fall off by the end of the two remaining spins). Accordingly, determinations only need be made for walking symbols placed on the two rightmost reels (e.g., instead of all five reels), continuing the above example, resulting in improved computer efficiency and saved computer resources.

In the example embodiment, an electronic gaming system is described that includes at least one memory with instructions stored thereon and at least one processor in communication with the at least one memory wherein the instructions, when executed by the at least one processor, cause the at least one processor to cause display of a first display area including a plurality of symbol positions for an electronic game and determine a respective symbol for each symbol position of the plurality of symbol positions for a play of the electronic game wherein the respective symbols include at least one bonus symbol and wherein the at least one bonus symbol is associated with an output amount.

In the example embodiment the instructions further cause the at least one processor to cause the at least one bonus symbol to advance at least one symbol position of the plurality of symbol positions toward an edge of the plurality of symbol positions for a next play of the electronic game. The instructions also cause the at least one processor to, after a play of the electronic game where the at least one bonus symbol is displayed at a symbol position of the plurality of symbol positions adjacent to the edge of the plurality of symbol positions, cause display of at least a portion of the at least one bonus symbol in a second display area wherein display of at least the portion of the at least one bonus symbol indicates that the output amount will be provided for the electronic game and cause the output amount associated with the at least one bonus symbol to be provided.

In some embodiments, the instructions further cause the at least one processor to cause the electronic game to be provided for a predefined number of plays. In some embodiments, the instructions further cause the at least one processor to cause the output amount to be provided after a last play of the predefined number of plays.

In some embodiments, the electronic game is a feature game that is triggered from a base game and the instructions further cause the at least one processor to cause the feature game to be randomly triggered during play of the base game.

In some embodiments, the instructions further cause the at least one processor to cause the at least one bonus symbol to be upgraded to at least one upgraded bonus symbol and, for each at least one upgraded bonus symbol, cause a bonus output to be provided wherein the bonus output includes at least one of an additional output amount or a multiplier to the output amount.

In some embodiments, when a predefined number of bonus symbols are displayed, the instructions further cause the at least one processor to cause a bonus game to be triggered based upon the predefined number of bonus symbols being displayed wherein each of the predefined number of bonus symbols is associated with a respective output amount, cause the predefined number of bonus symbols to remain displayed during the bonus game, and provide a bonus game output amount wherein the bonus game output amount includes the respective output amounts associated with each of the predefined number of bonus symbols and any output amounts associated with additional bonus symbols provided during the bonus game.

In some embodiments, the instructions further cause the at least one processor to determine the respective symbols based upon at least one message received from at least one server. In some embodiments, the instructions further cause the at least one processor to at least one of cause display of the first display area, cause the at least one bonus symbol to advance the at least one symbol position of the plurality of symbol positions toward the edge of the plurality of symbol positions, or cause display of at least the portion of the at least one bonus symbol in the second display area by transmitting at least one message to a gaming device where the first display area and the second display area are displayed.

The description provided herein includes certain examples and exemplary use cases. It should be understood that these examples and use cases are included herein for illustrative purposes, and these examples and use cases should not be taken to limit the present disclosure. The systems and methods described herein may be used in many other use cases.

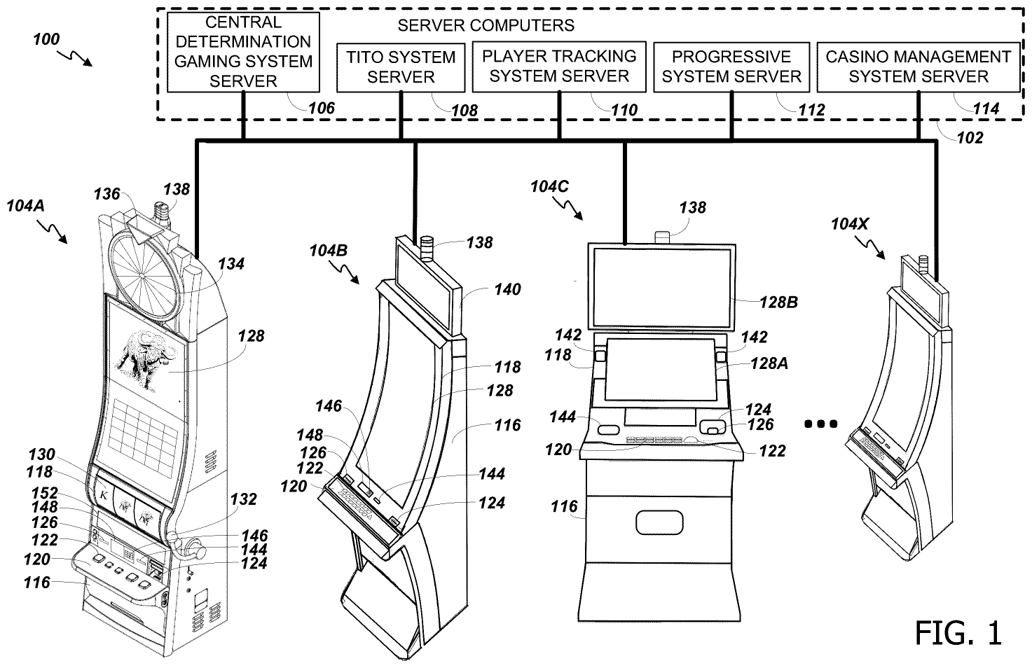

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

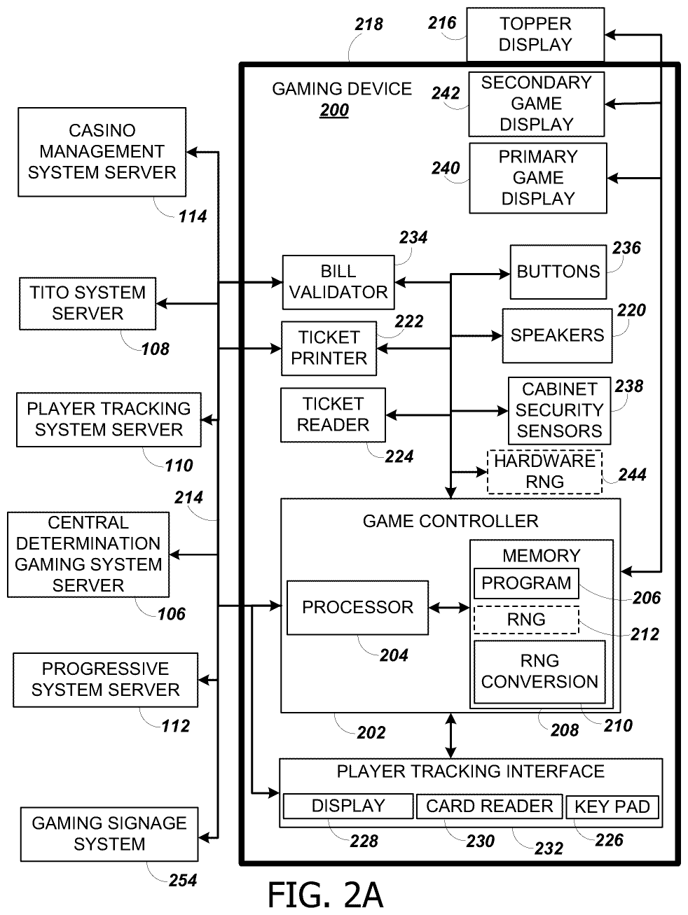

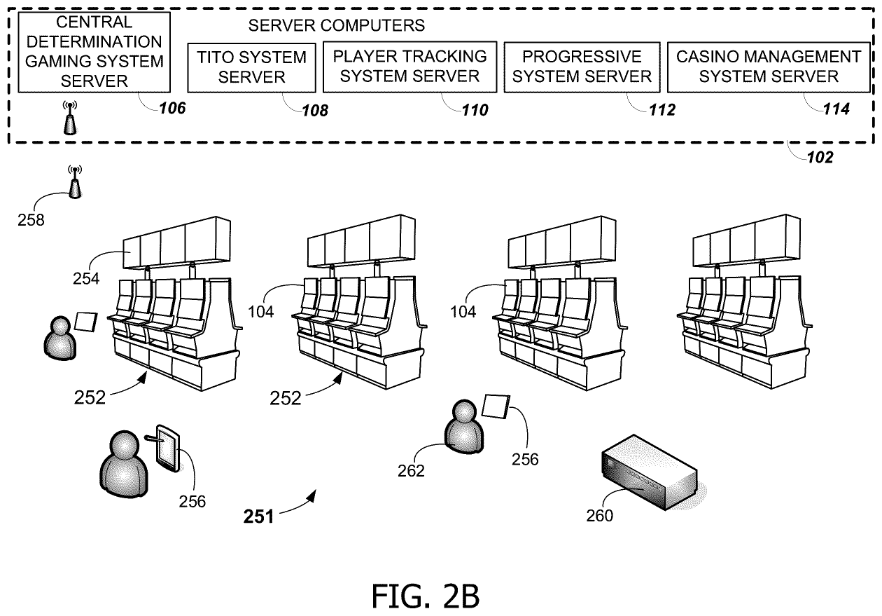

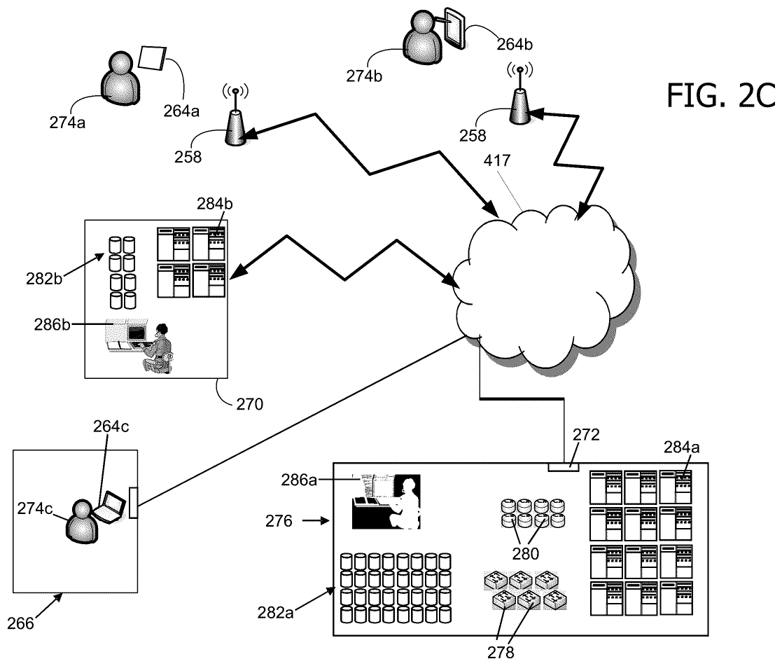

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat© Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

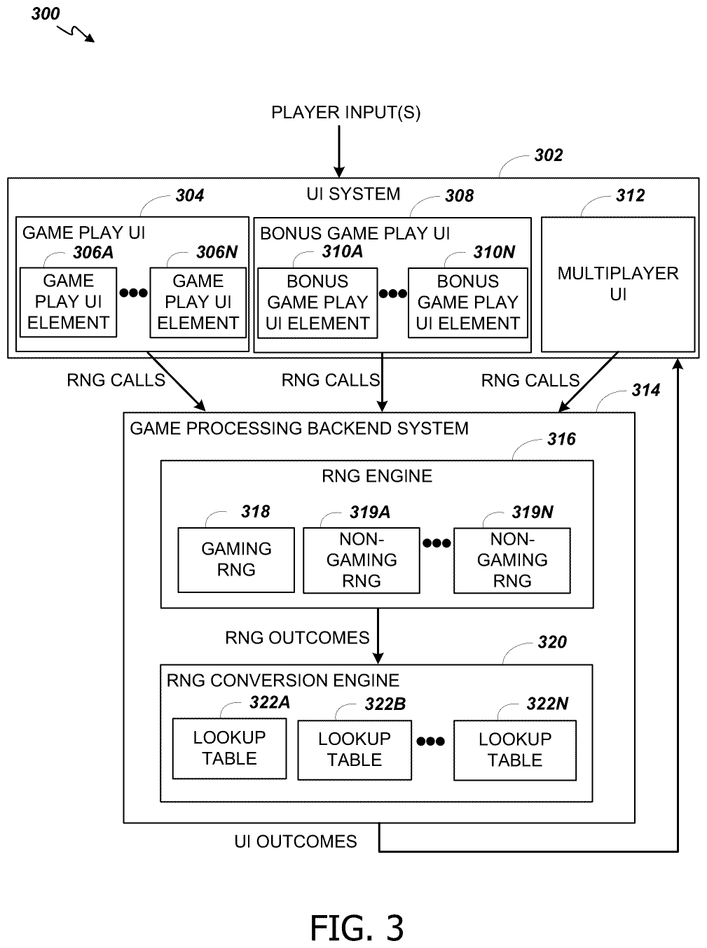

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

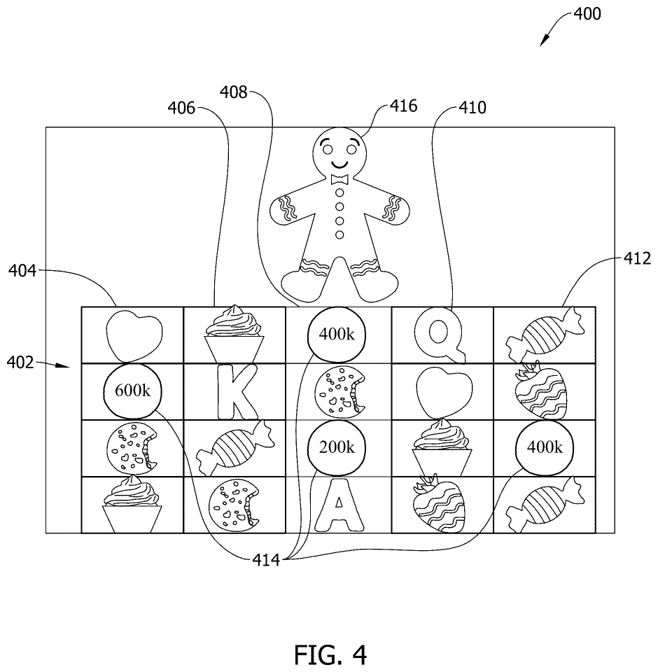

FIG. 4 illustrates an example screenshot and/or interface 400 of an electronic game, as described herein. As shown in FIG. 4, a matrix 402 is provided that includes five reels 404-412. Four COR symbols 414 are also provided. In the example embodiment, the electronic game shown in FIG. 4 is a base game during which the other electronic games described herein may be triggered. During the base game, reels 404-412 spin and COR symbols 414 are available (e.g., randomly selected) to land (e.g., be provided in the game outcome). While reels 404-412 spin, COR symbols 414 move one space to the right (e.g., or in any direction). Once COR symbols 414 reach an edge of matrix 402 (e.g., reel 412), during a next spin those COR symbols 414 may be displayed as falling out of (e.g., disappearing from) matrix 402.

It should be appreciated that while the example games described herein are shown with a gumball theme (e.g., gumballs, gumball machine, basket catching gumballs), different themes are also envisioned in accordance with the spirit of the disclosure.

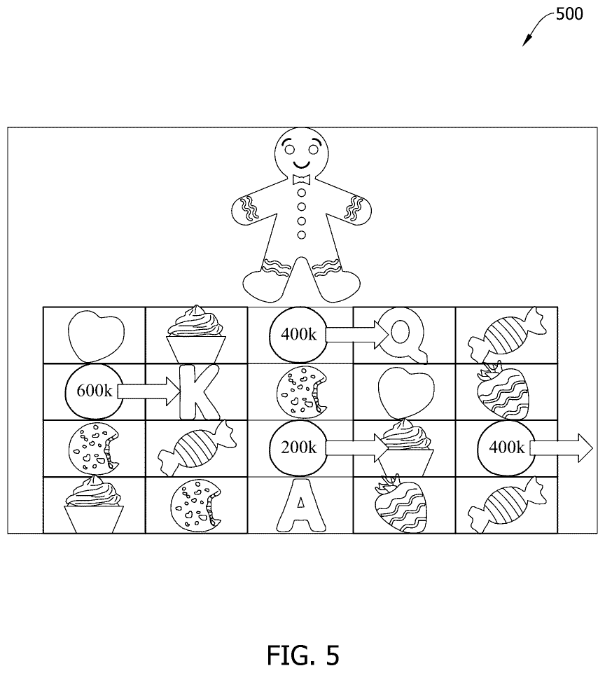

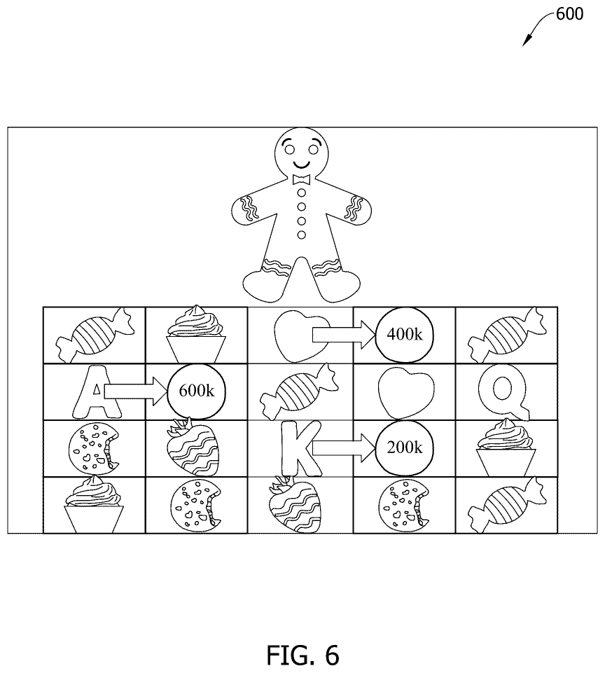

FIG. 5 illustrates an example screenshot and/or interface 500 of the electronic game shown in FIG. 4 indicating that COR symbols 414 will move one space to the right (e.g., the arrows, in FIG. 4 and other FIGS. where arrows are shown, are provided herein for illustrative purposes and may not be displayed during actual play of the electronic game) while FIG. 6 illustrates an example screenshot and/or interface 600 where COR symbols 414 have moved one space to the right (e.g., as compared to FIGS. 4 and 5) including a 400k COR symbol 414 disappearing from matrix 402.

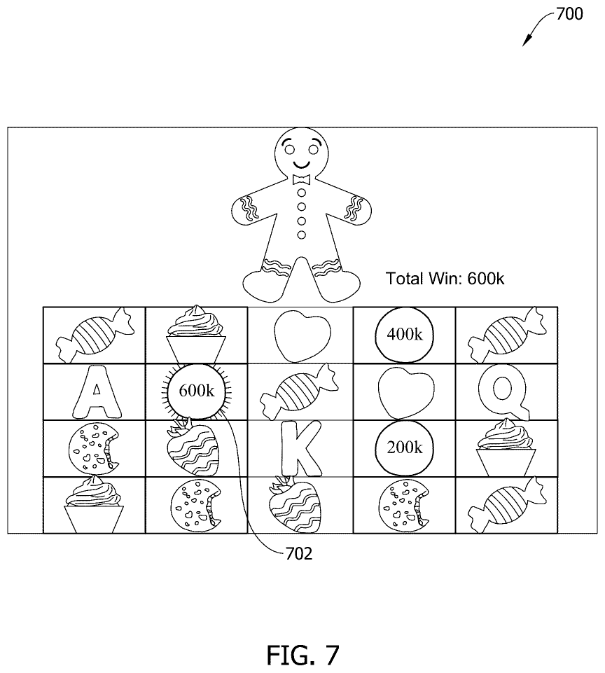

FIG. 4 also includes a mascot 416 that may be shown as triggering certain bonuses during gameplay. For example, FIG. 7 illustrates an example screenshot and/or interface 700 where an instant award (e.g., 600k) is provided (e.g., randomly) and mascot 416 may be animated as providing the instant award. The 600 k COR symbol 414 is highlighted 702 as corresponding to the instant award. In other words, a displayed COR symbol 414 may be randomly determined to be instantly provided (e.g., outside of a game outcome) and mascot 416 may be animated as providing (e.g., selecting) the COR symbol 414 that is randomly selected to communicate to a player which COR symbol 414 is selected to be provided. In the example embodiment, COR symbols 414 selected to be instantly awarded remain displayed after being awarded and gameplay (e.g., “walking” of COR symbols 414) continues as usual.

As another example, mascot 416 may be displayed as adding one or more additional COR symbols 414 to matrix 402. For example, it may be randomly determined to add a COR symbol 414 to matrix 402 (e.g., which COR symbol 414 to add may also be randomly determined) and mascot 416 may be displayed as adding the determined COR symbol 414 to matrix 402.

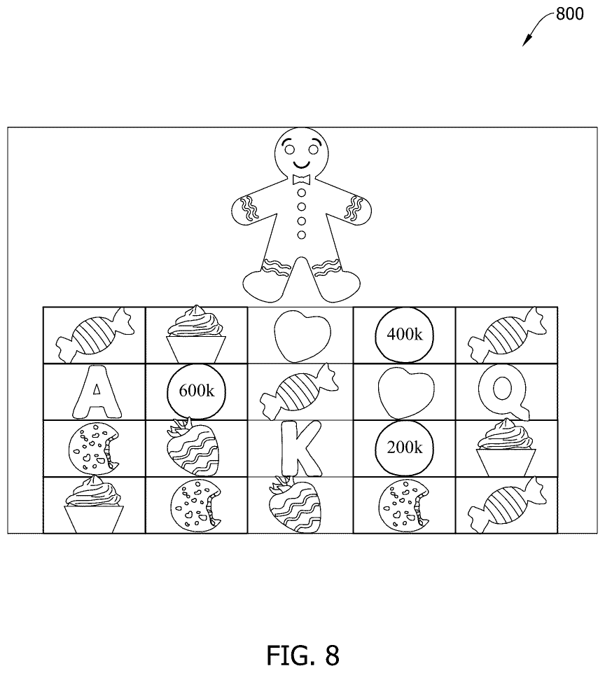

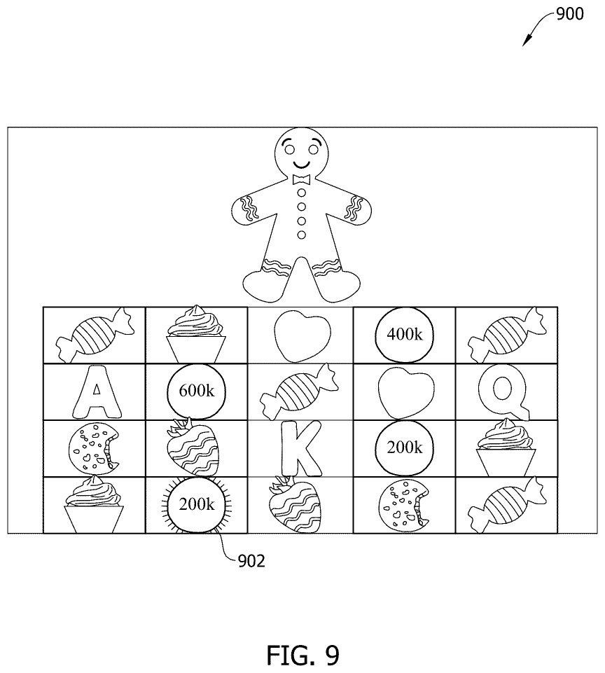

FIG. 8 illustrates an example screenshot and/or interface 800 before an additional COR symbol 414 is provided and FIG. 9 illustrates an example screenshot and/or interface 900 after an additional COR symbol 414 is provided (e.g., the 200 k COR symbol 414 in reel 406). The 200 k COR symbol 414 is illustrated as being highlighted 902 in FIG. 9 to communicate that it was the COR symbol 414 added to matrix 402.

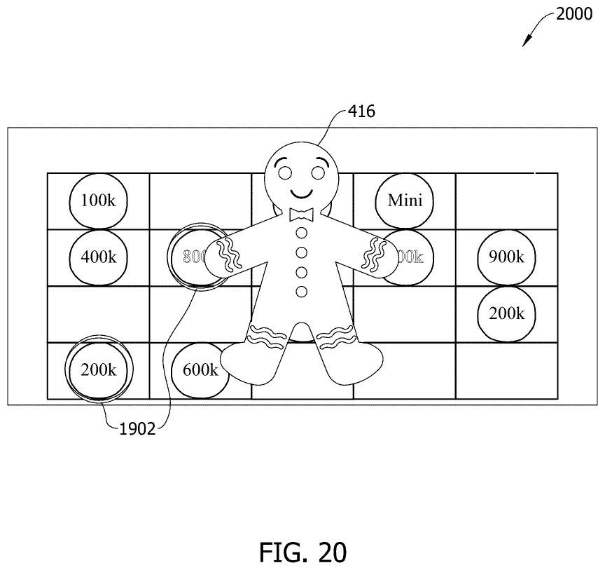

In some embodiments, mascot 416 may be displayed as converting COR symbols 414 to bonus COR symbols (e.g., see FIG. 20).

In some embodiments, values associated with COR symbols 414 displayed in matrix 402 may not be provided as awards. Rather, COR symbols 414 displayed in matrix 402 (e.g., during the base game) may be used to trigger the bonus and/or feature game. Then, in the bonus and/or feature game, the values associated with COR symbols 414 may be eligible to be provided as awards.

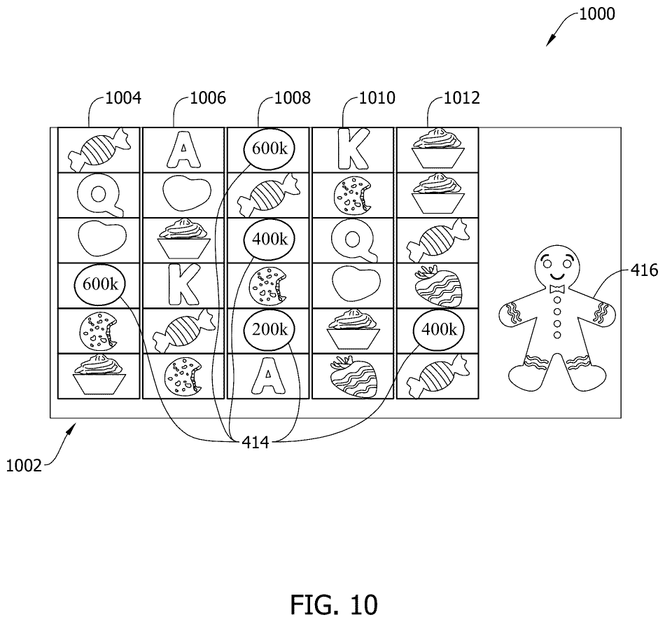

As explained herein, different electronic games (e.g., bonus games and/or feature games) may be triggered during play of a base game (e.g., the electronic game shown in FIGS. 4-9). FIG. 10 illustrates an example screenshot and/or interface 1000 of an electronic game including output accumulation, as described herein. In some embodiments, the electronic game shown in FIG. 10 is a feature game triggered upon a predefined/threshold number of trigger symbols (e.g., COR symbols 414) being displayed during play of a base game (e.g., or any other trigger condition). In some embodiments, the feature game may be triggered randomly, by a mystery trigger (e.g., a trigger condition unknown to the player), or by an input of an amount of a secondary currency. For instance, in some secondary currency examples, secondary currency may be accumulated in a player account (e.g., the secondary currency may be earned in a variety of ways such as by playing certain games, playing a game for a certain amount of time, etc.) and the secondary currency may be spent to trigger the feature game.

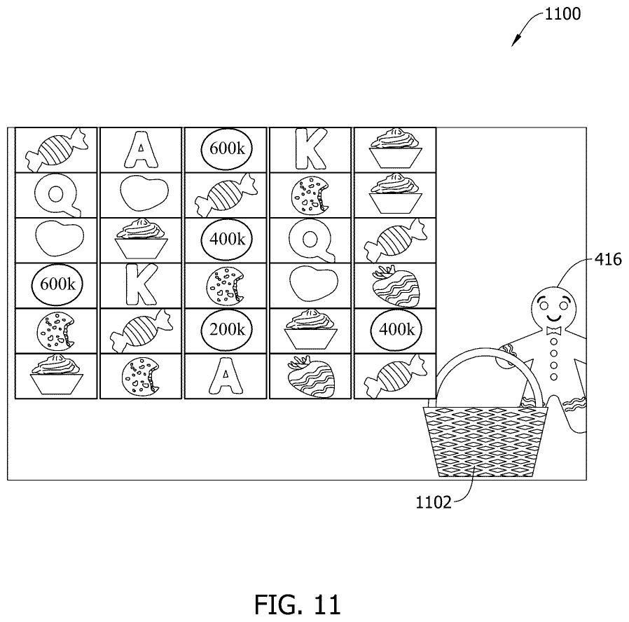

As shown in FIG. 10, screenshot and/or interface 1000 includes a matrix 1002 (e.g., a first display area) including reels 1004-1012. COR symbols 414 from the base game (e.g., that caused the feature game to be triggered) remain displayed along with mascot 416. During play of the feature game, mascot 416 may provide any features described herein and/or any additional features. Notably, in the example embodiment of the feature game shown in FIG. 10, COR symbols 414 that “fall off” of matrix 1002 are “caught” by mascot 416 (e.g., in a basket) and, at the end of the feature game, a sum of values associated with any caught COR symbols 414 is provided. For example, FIG. 11 illustrates an example screenshot and/or interface 1100 where mascot 416 is displayed as holding a basket 1102 to catch COR symbols 414.

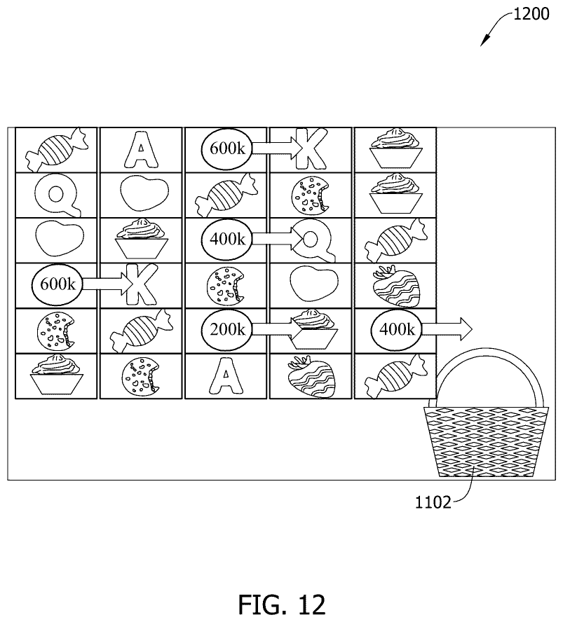

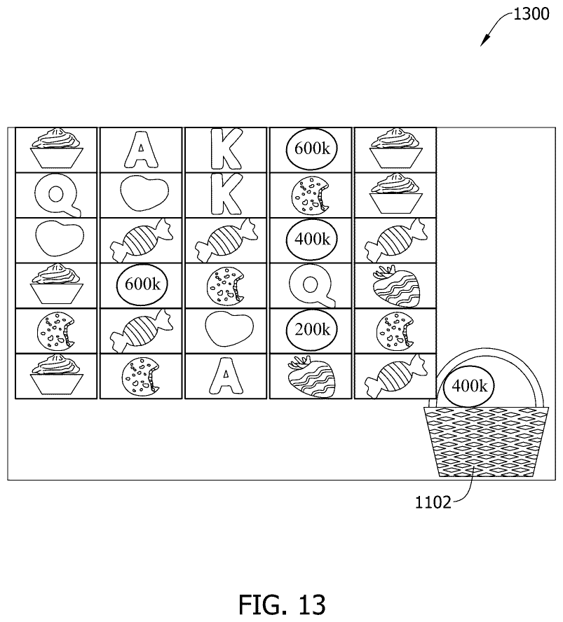

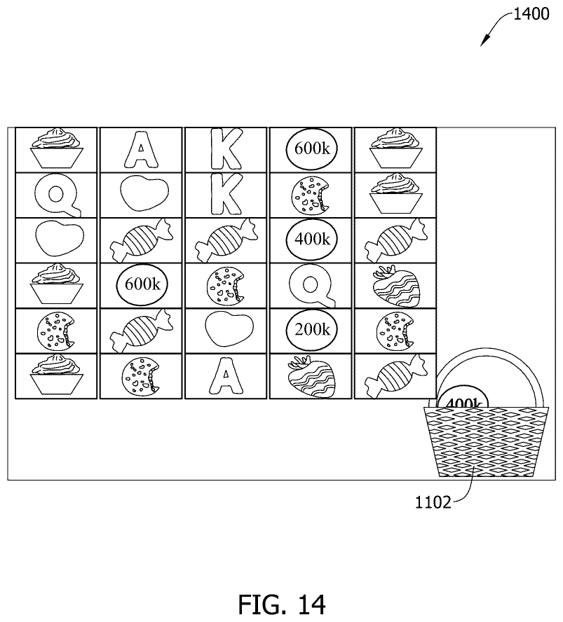

FIG. 12 illustrates an example screenshot and/or interface 1200 showing that COR symbols 414 will advance across matrix 1002 (e.g., COR symbols 414 “walk” in the feature game, as explained herein). Accordingly, FIG. 13 illustrates an example screenshot and/or interface 1300 with COR symbols 414 being one position to the right (e.g., as compared to FIG. 12) and a 400k COR symbol 414 falling off of matrix 1002 while FIG. 14 illustrates an example screenshot and/or interface 1400 where the 400 k COR symbol 414 has fallen into basket 1102 (e.g., in a second display area) to show/communicate that 400 k credits (e.g., at least) will be provided (e.g., at the end of the feature game).

Further, FIG. 15 illustrates an example screenshot and/or interface 1500 where a plurality of COR symbols 414 have been collected in basket 1102. In some embodiments, a prize bank (e.g., a credit meter) may display a total number of credits associated with any COR symbols 414 (e.g., a sum) shown in basket 1102 (e.g., or other collector) to communicate a total amount of credits “collected” thus far that will be provided at the end of the feature game. Accordingly, the information displayed communicates clearly that COR symbols 414 will be collected during the feature game (e.g., instead of simply disappearing) and that values associated therewith will be provided at the end of the feature game.

While the example feature game described herein is described with respect to basket 1102 collecting any number of COR symbols 414, additional and/or alternative embodiments are also envisioned. For example, in some embodiments, basket 1102 may only “catch” certain COR symbols 414 while other COR symbols 414 may fall out of matrix 1002 and disappear (e.g., and credit values associated with COR symbols 414 that are not caught are not awarded).

In some embodiments, basket 1102 may only hold COR symbols 414 up until a threshold number of credits associated with COR symbols 414 in basket 1102 has been achieved (e.g., a 1 M credit threshold). In some embodiments, once the threshold has been reached, additional COR symbols that fall off of matrix 1002 may disappear and not be provided or may be instantly provided as an instant award (e.g., and displayed as bouncing off of basket 1102).

In some embodiments, basket 1102 may only hold a certain number of COR symbols 414 (e.g., basket 1102 may include ten slots that may be filled by COR symbols 414). In some embodiments, once the slots have been filled, additional COR symbols that fall off of matrix 1002 may disappear and not be provided or may be instantly provided as an instant award (e.g., and displayed as bouncing off of basket 1102).

In some embodiments, certain COR symbols 414 in certain slots of basket 1102 may be replaced as additional COR symbols 414 fall out of matrix 1002. For example, in some embodiments if a COR symbol 414 associated with a credit value higher than a COR symbol 414 currently in basket 1102 falls out of matrix 1002, the COR symbol 414 associated with the lowest credit value in basket 1102 (e.g., or any COR symbol 414 in basket 1102 associated with a credit value lower than the credit value associated with the falling COR symbol 414) may be replaced by the COR symbol 414 falling out of matrix 1002. In some embodiments, only COR symbols 414 associated with credit values that satisfy a predefined threshold may be added to basket 1102.

In some embodiments, a player may be provided with the option to select (e.g., at a player interface) whether or not to replace any COR symbols 414 currently in basket 1102 with any falling COR symbols 414.

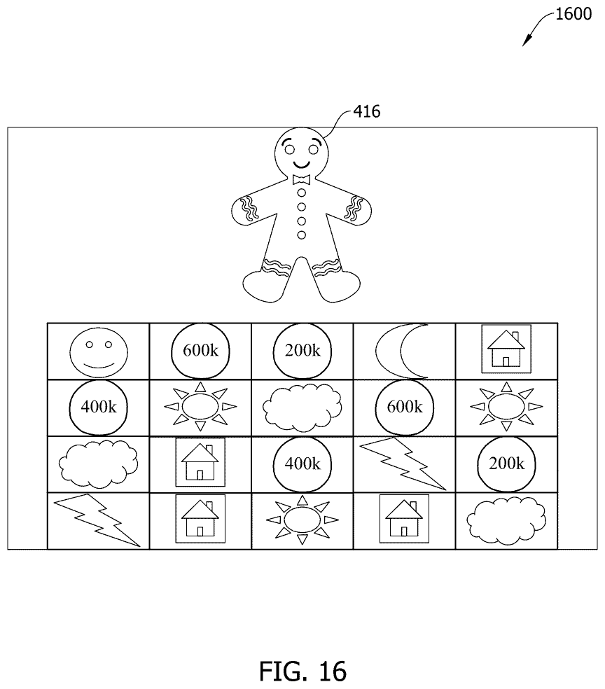

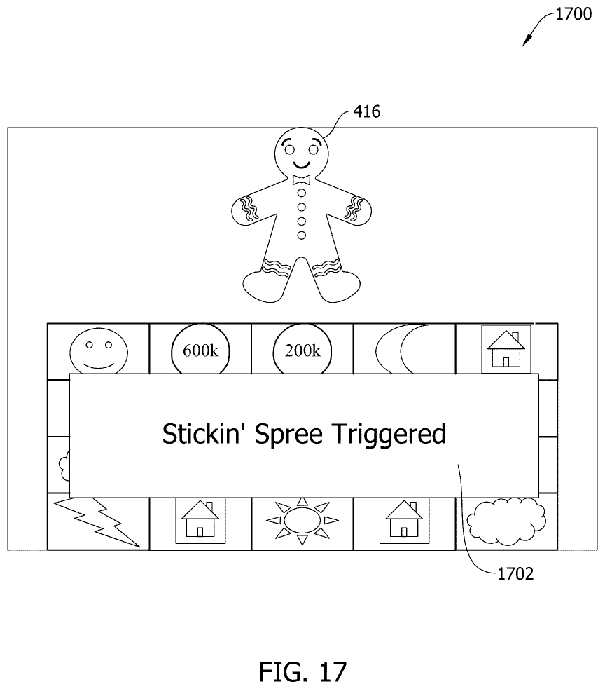

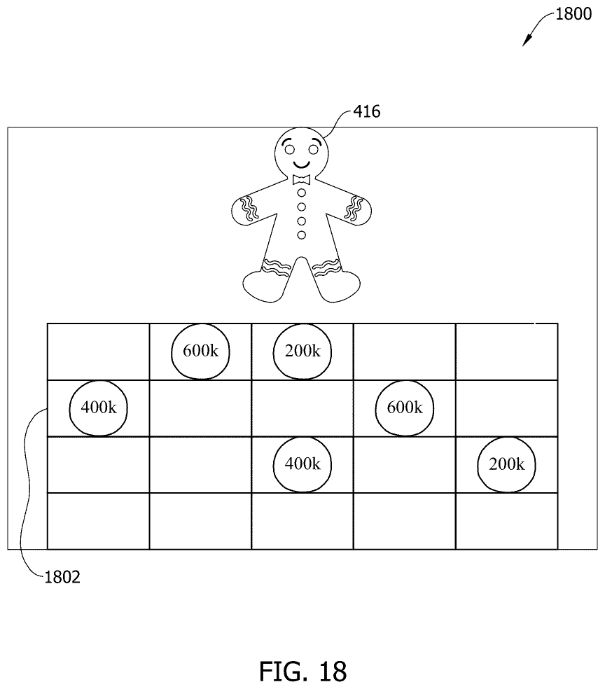

FIG. 16 illustrates an example screenshot and/or interface 1600 of the electronic game shown in FIG. 18 being triggered. In other words, FIG. 16 illustrates an example of a base game (e.g., as shown in FIGS. 4-9) where a predefined/threshold number of COR symbols 414 are provided that triggers a bonus game (e.g., the game shown in FIG. 18). Accordingly, FIG. 17 illustrates an example screenshot and/or interface 1700 with a message 1702 indicating that the bonus game (e.g., a stickin' spree game) has been triggered (e.g., because of the number of COR symbols 414 shown in FIG. 16).

FIG. 18 illustrates an example screenshot and/or interface 1800 of an electronic game (e.g., a bonus game). As shown in FIG. 18, a matrix 1802 is provided with COR symbols 414 displayed therein. Mascot 416 is also provided and may provide any features described herein (e.g., and/or any additional features).

The electronic game shown in FIG. 18 may be a bonus game that is triggered from the electronic game shown in FIGS. 4-9 or the electronic game (e.g., the feature game) shown in FIGS. 10-15. As one example, the bonus game shown in FIG. 18 may be triggered upon a predefined/threshold number of COR symbols 414 (e.g., six COR symbols 414) being displayed during the electronic game shown in FIGS. 4-9 or the electronic game shown in FIGS. 10-15.

Continuing the example where the bonus game in FIG. 18 is triggered based upon six COR symbols 414 being displayed in a different electronic game, FIG. 18 shows six COR symbols 414 in matrix 1802 (e.g., the COR symbols 414 that triggered the bonus game). Instead of “walking” across matrix 1802, in the bonus game shown in FIG. 18 COR symbols 414 remain displayed at their respective symbol positions during play of the game. In other words, COR symbols 414 may be held/stuck in place (e.g., a “hold and spin” or “stickin' spree” game) and, at the end of the bonus game, values associated with all displayed COR symbols 414 are provided. For example, each symbol position of matrix 1802 without a COR symbol 414 displayed therein may be spun and stopped independently of other symbol positions during the bonus game (e.g., each symbol position is its own reel).

A predefined number of spins (e.g., three spins) may be provided at the start of the bonus game. Upon a new COR symbol 414 being displayed (e.g., at a symbol position not previously displaying a COR symbol 414 during the bonus game), the number of spins remaining may be reset to the predefined number of spins. The bonus game may end when no spins remain or when each symbol position of matrix 1802 includes a COR symbol 414 displayed therein (e.g., a “blackout” pattern). For example, upon each symbol position of matrix 1802 including a COR symbol 414 displayed therein, a grand jackpot may be provided that is otherwise not eligible to be won.

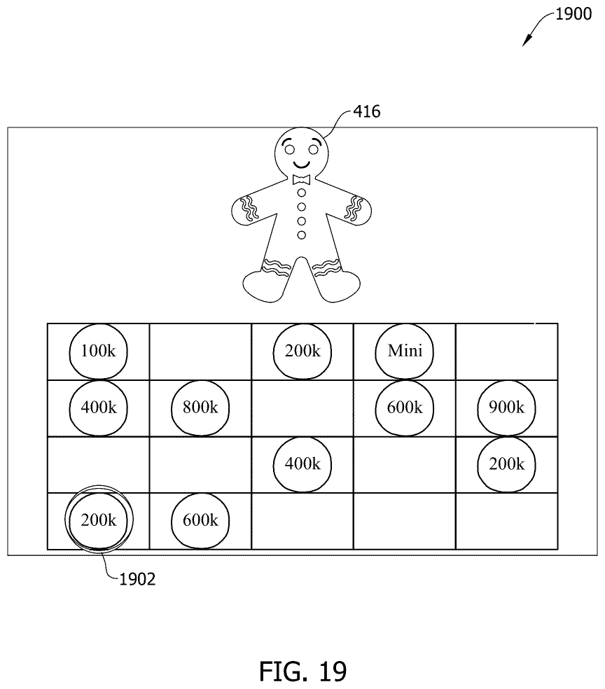

FIG. 19 illustrates an example screenshot and/or interface 1900 where more COR symbols 414 have been provided during one or more subsequent spins of the bonus game. Further, one COR symbol 414 has been upgraded to a bonus COR symbol 1902. For example, a random determination may be made as to whether a COR symbol 414 should be upgraded to a bonus COR symbol 1902 and/or which COR symbol 414 should be upgraded to a bonus COR symbol 1902.

FIG. 20 illustrates a next example screenshot and/or interface 2000 where another COR symbol 414 is being upgraded to a bonus COR symbol 1902 (e.g., and mascot 416 is animated/displayed as upgrading the 800 k COR symbol 414 to a bonus COR symbol 1902).

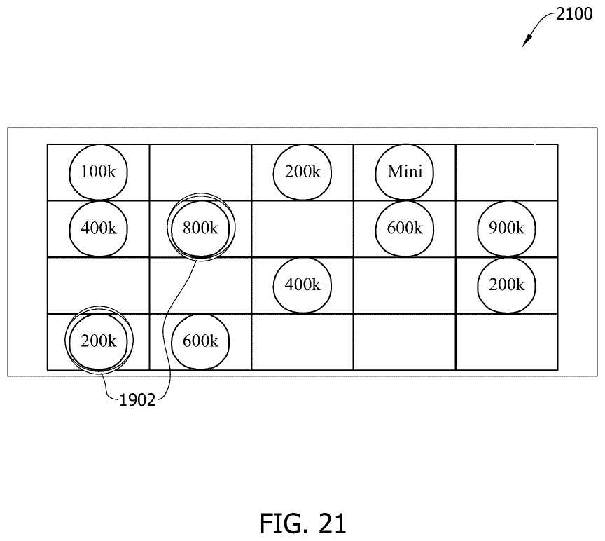

FIG. 21 illustrates a next example screenshot and/or interface 2100 showing COR symbols 414 provided in this example of the bonus game as well as bonus COR symbols 1902 provided in this example of the bonus game. In some embodiments, a random determination of which COR symbols 414 should be upgraded to bonus COR symbols 1902 may be made at the end of the bonus game (e.g., after a last spin/play of the bonus game).

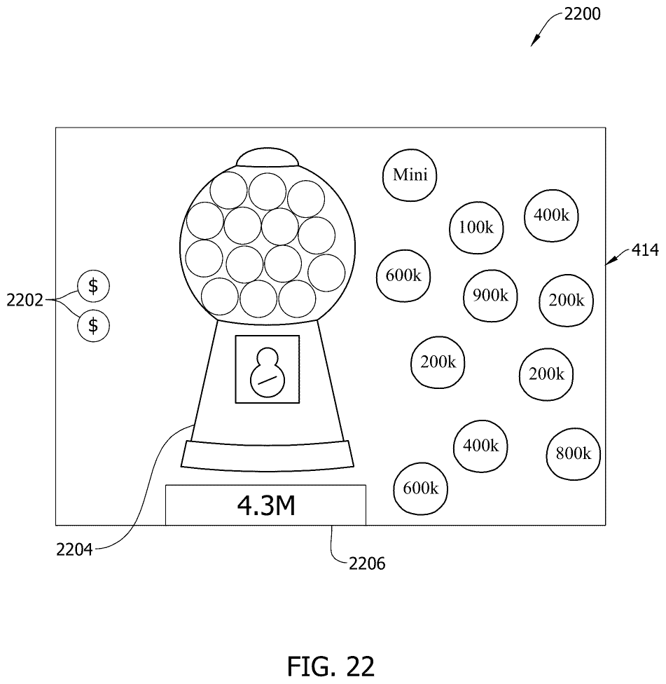

FIG. 22 illustrates an example screenshot and/or interface 2200 of an electronic game where bonus COR symbols 1902 may be utilized and/or redeemed. For example, corresponding to the two bonus COR symbols 1902 shown in FIG. 21, two tokens 2202 are shown in FIG. 22. In the example of FIG. 22, tokens 2202 may be redeemed at machine 2204 (e.g., a gumball machine) to receive random prizes. As some examples, random prizes may include credits (e.g., pink gumballs), multipliers (e.g., purple gumballs), and/or jackpots (e.g., yellow gumballs). For instance, in examples where different colors of gumballs are associated with different types of prizes, upon redemption of a token 2202 the color of a gumball may first be shown to a player. Then (e.g., after a predetermined period of time to build anticipation), a prize (e.g., credit amount and/or multiplier amount) may be revealed.

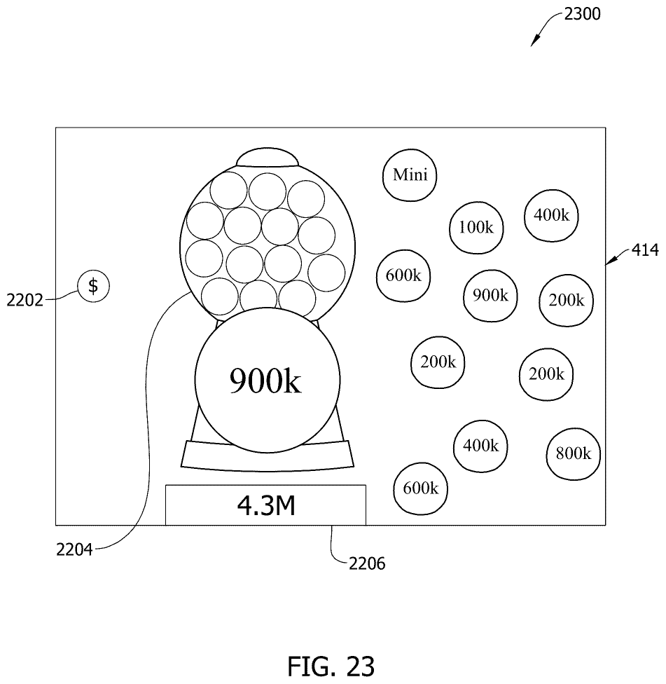

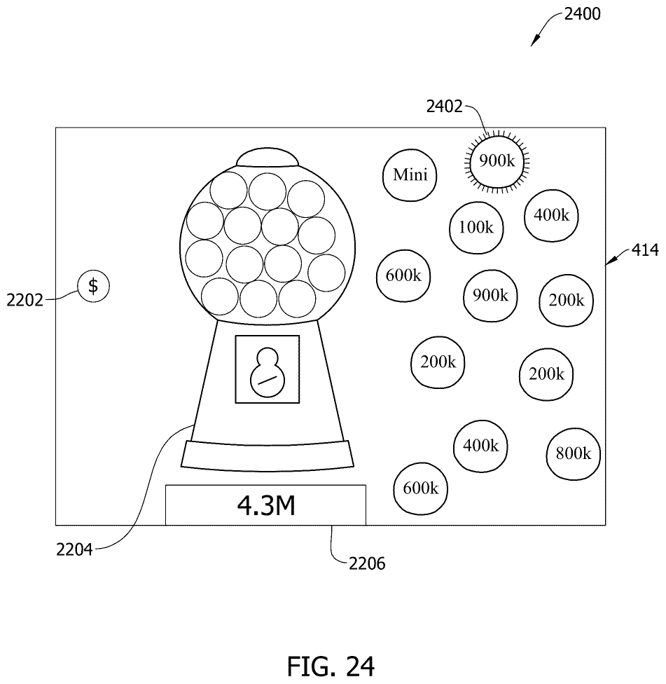

COR symbols 414 shown in FIG. 22 correspond to COR symbols 414 shown in FIG. 21 at the end of the bonus game. A sum of the COR symbols 414 displayed in FIG. 21 (e.g., and FIG. 22) is shown in credit meter 2206. Advancing to FIG. 23, a next example screenshot and/or interface 2300 is provided after one token 2202 has been redeemed at machine 2204 (e.g., animated as being inserted into machine 2204) and a new 900k COR symbol 414 (e.g., as randomly determined) is displayed as being presented by machine 2204. Accordingly, as shown in example screenshot and/or interface 2400 of FIG. 24, the new 900k COR symbol 414 is highlighted 2402 (e.g., indicating that it is the new COR symbol 414 being added) and displayed with the other COR symbols 414 and only one token 2202 remains.

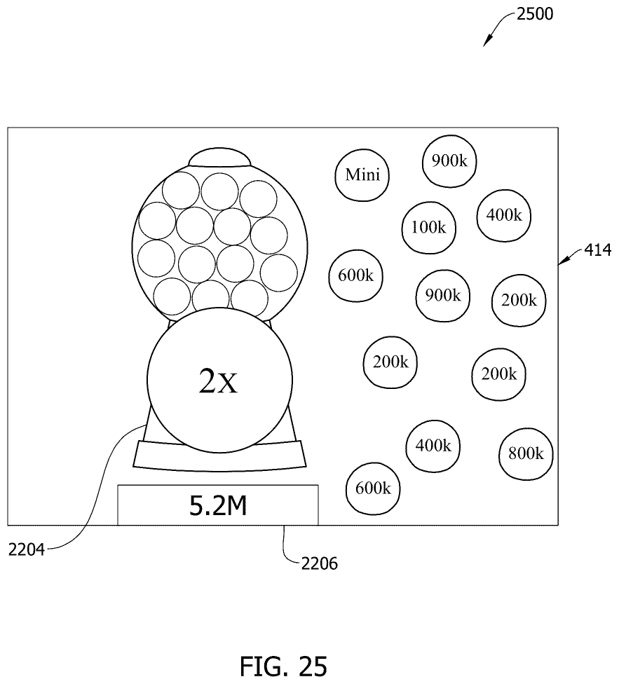

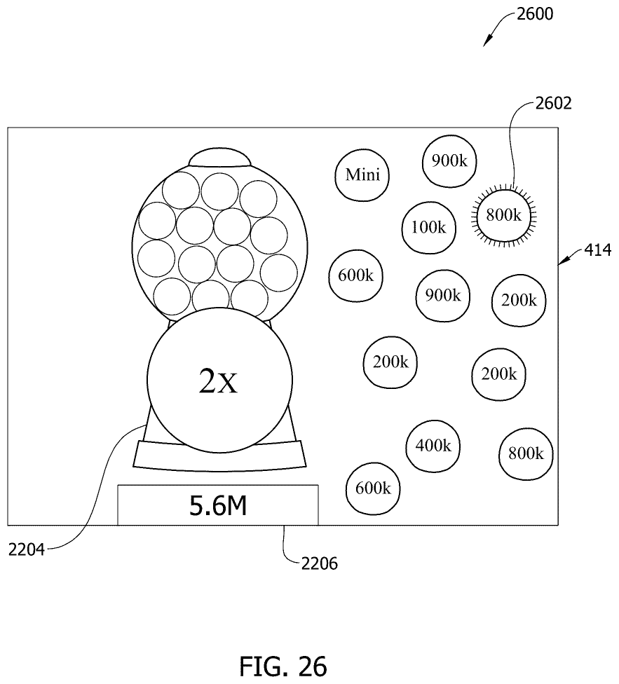

Advancing to FIG. 25, example screenshot and/or interface 2500 illustrates that credit meter 2206 has been updated from 4.3 M to 5.2 M (e.g., accounting for the addition of the 900 k COR symbol 414) and another token 2202 has been redeemed at machine 2204. In this example, a multiplier is randomly provided by machine 2204 (e.g., a 2× multiplier). A determination is then made as to which COR symbol(s) 414 the multiplier will be applied to. In FIG. 26, an example screenshot and/or interface 2600 is provided with an 800 k COR symbol 414 being highlighted 2602 to indicate that the 2× multiplier was applied to the corresponding 400 k COR symbol 414 shown in FIG. 25. In some embodiments, multipliers may be applied to any number of COR symbols 414.

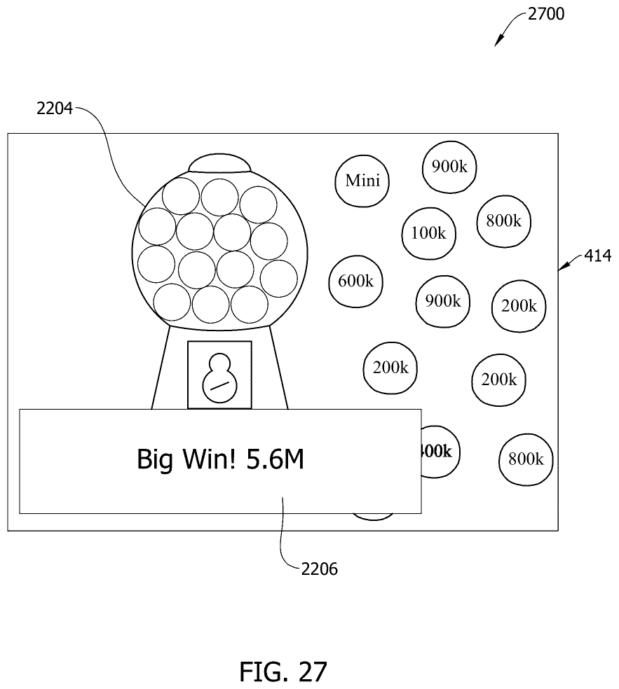

Accordingly, FIG. 27 illustrates a next example screenshot and/or interface 2700 where the 2× multiplier has been applied and credit meter 2206 is updated to display the new sum associated with the displayed COR symbols 414 (e.g., 5.2 M+400 k (e.g., based on updating the 400 k COR symbol 414 to an 800 k COR symbol 414 based on the 2× multiplier)=5.6 M). Because all tokens 2202 have been redeemed, the 5.6 M amount, as indicated by credit meter 2206, is provided.

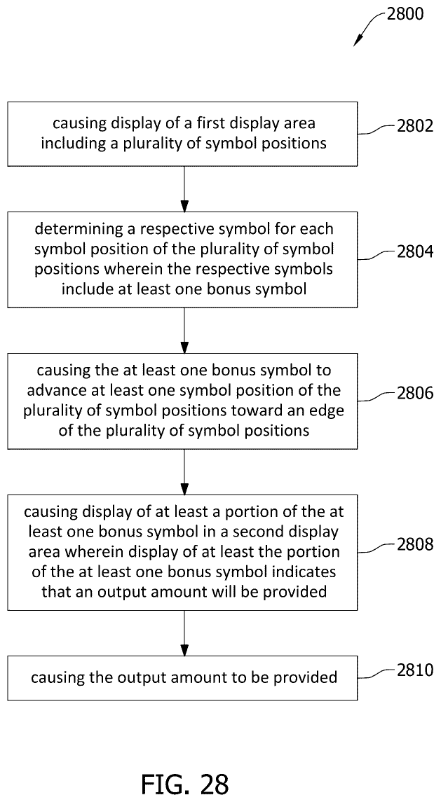

FIG. 28 illustrates an example method 2800 for output accumulation in electronic gaming, as described herein. In the example embodiment, method 2800 includes causing display 2802 of a first display area (e.g., matrix 1002) including a plurality of symbol positions for an electronic game and determining 2804 a respective symbol for each symbol position of the plurality of symbol positions for a play of the electronic game wherein the respective symbols include at least one bonus symbol and wherein the at least one bonus symbol is associated with an output amount.

In the example embodiment, method 2800 also includes causing 2806 the at least one bonus symbol to advance at least one symbol position of the plurality of symbol positions toward an edge of the plurality of symbol positions for a next play of the electronic game (e.g., see FIG. 12). In the example embodiment, method 2800 further includes, after a play of the electronic game where the at least one bonus symbol is displayed at a symbol position of the plurality of symbol positions adjacent to the edge of the plurality of symbol positions, causing display 2808 of at least a portion of the at least one bonus symbol in a second display area wherein display of at least the portion of the at least one bonus symbol indicates that the output amount will be provided for the electronic game (e.g., see FIGS. 13-15) and causing 2810 the output amount associated with the at least one bonus symbol to be provided.

In some embodiments, method 2800 includes causing the electronic game to be provided for a predefined number of plays and causing the output amount to be provided after a last play of the predefined number of plays.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming device comprising:
at least one memory with instructions stored thereon; and
at least one processor in communication with the at least one memory, wherein the instructions, when executed by the at least one processor, cause the at least one processor to:
cause display of a first display area comprising a plurality of symbol positions for an electronic game;
determine a respective symbol for each symbol position of the plurality of symbol positions for a play of the electronic game, wherein the respective symbols comprise at least one bonus symbol, and wherein the at least one bonus symbol is associated with an output amount;
cause the at least one bonus symbol to advance at least one symbol position of the plurality of symbol positions toward an edge of the plurality of symbol positions for a next play of the electronic game;
after a play of the electronic game where the at least one bonus symbol is displayed at a symbol position of the plurality of symbol positions adjacent to the edge of the plurality of symbol positions, cause display of at least a portion of the at least one bonus symbol in a second display area, wherein display of at least the portion of the at least one bonus symbol indicates that the output amount will be provided for the electronic game; and
cause the output amount associated with the at least one bonus symbol to be provided.

2. The electronic gaming device of claim 1, wherein the instructions further cause the at least one processor to cause the electronic game to be provided for a predefined number of plays.

3. The electronic gaming device of claim 2, wherein the instructions further cause the at least one processor to cause the output amount to be provided after a last play of the predefined number of plays.

4. The electronic gaming device of claim 1, wherein the electronic game is a feature game that is triggered from a base game.

5. The electronic gaming device of claim 4, wherein the instructions further cause the at least one processor to cause the feature game to be randomly triggered during play of the base game.

6. The electronic gaming device of claim 1, wherein the instructions further cause the at least one processor to cause the at least one bonus symbol to be upgraded to at least one upgraded bonus symbol.

7. The electronic gaming device of claim 6, wherein the instructions further cause the at least one processor to, for each at least one upgraded bonus symbol, cause a bonus output to be provided, wherein the bonus output comprises at least one of an additional output amount or a multiplier to the output amount.

8. The electronic gaming device of claim 1, wherein the instructions further cause the at least one processor to, when a predefined number of bonus symbols are displayed:
cause a bonus game to be triggered based upon the predefined number of bonus symbols being displayed, wherein each of the predefined number of bonus symbols is associated with a respective output amount;
cause the predefined number of bonus symbols to remain displayed during the bonus game; and
provide a bonus game output amount, wherein the bonus game output amount comprises the respective output amounts associated with each of the predefined number of bonus symbols and any output amounts associated with additional bonus symbols provided during the bonus game.

9. The electronic gaming device of claim 1, wherein the instructions further cause the at least one processor to determine the respective symbols based upon at least one message received from at least one server.

10. At least one non-transitory computer-readable storage medium with instructions stored thereon that, in response to execution by at least one processor, cause the at least one processor to:
cause display of a first display area comprising a plurality of symbol positions for an electronic game;
determine a respective symbol for each symbol position of the plurality of symbol positions for a play of the electronic game, wherein the respective symbols comprise at least one bonus symbol, and wherein the at least one bonus symbol is associated with an output amount;
cause the at least one bonus symbol to advance at least one symbol position of the plurality of symbol positions toward an edge of the plurality of symbol positions for a next play of the electronic game;
after a play of the electronic game where the at least one bonus symbol is displayed at a symbol position of the plurality of symbol positions adjacent to the edge of the plurality of symbol positions, cause display of at least a portion of the at least one bonus symbol in a second display area, wherein display of at least the portion of the at least one bonus symbol indicates that the output amount will be provided for the electronic game; and
cause the output amount associated with the at least one bonus symbol to be provided.

11. The at least one non-transitory computer-readable storage medium of claim 10, wherein the instructions further cause the at least one processor to cause the electronic game to be provided for a predefined number of plays.

12. The at least one non-transitory computer-readable storage medium of claim 11, wherein the instructions further cause the at least one processor to cause the output amount to be provided after a last play of the predefined number of plays.

13. The at least one non-transitory computer-readable storage medium of claim 10, wherein the electronic game is a feature game that is triggered from a base game.

14. The at least one non-transitory computer-readable storage medium of claim 13, wherein the instructions further cause the at least one processor to cause the feature game to be randomly triggered during play of the base game.

15. The at least one non-transitory computer-readable storage medium of claim 10, wherein the instructions further cause the at least one processor to cause the at least one bonus symbol to be upgraded to at least one upgraded bonus symbol.

16. The at least one non-transitory computer-readable storage medium of claim 15, wherein the instructions further cause the at least one processor to, for each at least one upgraded bonus symbol, cause a bonus output to be provided, wherein the bonus output comprises at least one of an additional output amount or a multiplier to the output amount.

17. The at least one non-transitory computer-readable storage medium of claim 10, wherein the instructions further cause the at least one processor to, when a predefined number of bonus symbols are displayed:
cause a bonus game to be triggered based upon the predefined number of bonus symbols being displayed, wherein each of the predefined number of bonus symbols is associated with a respective output amount;
cause the predefined number of bonus symbols to remain displayed during the bonus game; and
provide a bonus game output amount, wherein the bonus game output amount comprises the respective output amounts associated with each of the predefined number of bonus symbols and any output amounts associated with additional bonus symbols provided during the bonus game.

18. The at least one non-transitory computer-readable storage medium of claim 10, wherein the instructions further cause the at least one processor to at least one of cause display of the first display area, cause the at least one bonus symbol to advance the at least one symbol position of the plurality of symbol positions toward the edge of the plurality of symbol positions, or cause display of at least the portion of the at least one bonus symbol in the second display area by transmitting at least one message to a gaming device where the first display area and the second display area are displayed.

19. A method of electronic gaming implemented by at least one processor in communication with at least one memory, the method comprising:
causing display of a first display area comprising a plurality of symbol positions for an electronic game;
determining a respective symbol for each symbol position of the plurality of symbol positions for a play of the electronic game, wherein the respective symbols comprise at least one bonus symbol, and wherein the at least one bonus symbol is associated with an output amount;
causing the at least one bonus symbol to advance at least one symbol position of the plurality of symbol positions toward an edge of the plurality of symbol positions for a next play of the electronic game;
after a play of the electronic game where the at least one bonus symbol is displayed at a symbol position of the plurality of symbol positions adjacent to the edge of the plurality of symbol positions, causing display of at least a portion of the at least one bonus symbol in a second display area, wherein display of at least the portion of the at least one bonus symbol indicates that the output amount will be provided for the electronic game; and
causing the output amount associated with the at least one bonus symbol to be provided.

20. The method of claim 19, further comprising:
causing the electronic game to be provided for a predefined number of plays; and
causing the output amount to be provided after a last play of the predefined number of plays.
